(19) United States
(12) Patent Application Publication
(10) Pub. No.: US 2024/0389134 A1
(43) Pub. Date: Nov. 21, 2024

(54) RANDOM ACCESS CHANNEL (RACH) RESOURCE INDICATION FOR REDUCED CAPABILITY AND COVERAGE ENHANCED USER EQUIPMENTS

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Tao LUO, San Diego, CA (US)

(21) Appl. No.: 18/576,664

(22) PCT Filed: Aug. 20, 2021
(86) PCT No.: PCT/CN2021/113771

§ 371 Date: Jan. 4, 2024

(51) Int. Cl. H04W 74/00; H04W 74/0833

(52) U.S. Cl. CPC H04W 74/004; H04W 74/0833

(57) ABSTRACT

Certain aspects of the present disclosure provide techniques for random access channel (RACH) configuration. Certain aspects are directed to a method for wireless communication by a user equipment (UE). The method generally includes: receiving, from a base station, a message comprising random access channel (RACH) configurations including a first RACH configuration indicating a first set of resources for reduced capability UEs supporting at least one first capability, a second RACH configuration indicating a second set of resources for coverage enhanced UEs supporting at least one second capability, and a third RACH configuration indicating a third set of resources for UEs supporting the at least one first capability and the at least one second capability; and transmitting a RACH message based on at least one of the RACH configurations.

### INTRODUCTION

Aspects of the present disclosure relate to wireless communications, and more particularly, to techniques for random access channel communication.

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, complex and dynamic environments can still attenuate or block signals between wireless transmitters and wireless receivers, undermining various established wireless channel measuring and reporting mechanisms, which are used to manage and optimize the use of finite wireless channel resources. Consequently, there exists a need for further improvements in wireless communications systems to overcome various challenges.

### SUMMARY

One aspect provides a method for wireless communication by a user equipment (UE). The method generally includes: receiving, from a base station, a message comprising random access channel (RACH) configurations including a first RACH configuration indicating a first set of resources for reduced capability UEs supporting at least one first capability, a second RACH configuration indicating a second set of resources for coverage enhanced UEs supporting at least one second capability, and a third RACH configuration indicating a third set of resources for UEs supporting the at least one first capability and the at least one second capability; and transmitting a RACH message based on at least one of the RACH configurations.

One aspect provides a method for wireless communication by a UE. The method generally includes: receiving, from a base station, a message comprising random access channel (RACH) configurations including a first RACH configuration indicating a first set of resources for reduced capability UEs supporting at least one first capability, a second configuration indicating a second set of resources for coverage enhanced UEs supporting at least one second capability, wherein the first set of resources and the second set of resources comprise overlapping resources; and transmitting a RACH message based on the RACH configurations.

One aspect provides a method for wireless communication by a base station (BS). The method generally includes: transmitting, to a UE, a message comprising random access channel (RACH) configurations including a first RACH configuration indicating a first set of resources for reduced capability UEs supporting at least one first capability, a second RACH configuration indicating a second set of resources for coverage enhanced UEs supporting at least one second capability, and a third RACH configuration indicating a third set of resources for UEs supporting the at least one first capability and the at least one second capability; and receiving a RACH message based on at least one of the RACH configurations.

One aspect provides a method for wireless communication by a base station (BS). The method generally includes: transmitting, to a UE, a message comprising random access channel (RACH) configurations including a first RACH configuration indicating a first set of resources for reduced capability UEs supporting at least one first capability, a second configuration indicating a second set of resources for coverage enhanced UEs supporting at least one second capability, wherein the first set of resources and the second set of resources comprise overlapping resources; and receiving a RACH message based on the RACH configurations.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

The appended figures depict certain features of the various aspects described herein and are not to be considered limiting of the scope of this disclosure.

FIG. 1 is a block diagram conceptually illustrating an example wireless communication network.

FIG. 2 is a block diagram conceptually illustrating aspects of an example of a base station and user equipment.

FIGS. 3A-3D depict various example aspects of data structures for a wireless communication network.

FIGS. 4A-4B depict example random access channel (RACH) procedures.

FIG. 5 illustrates RACH resources for legacy UEs, reduced capability (RedCap) UEs, and coverage enhanced (CovEnh) UEs, in accordance with certain aspects of the present disclosure.

FIG. 6 is a flow diagram illustrating example operations for wireless communication by a base station, in accordance with certain aspects of the present disclosure.

FIG. 7 is a flow diagram illustrating example operations for wireless communication by a user equipment, in accordance with certain aspects of the present disclosure.

FIG. 8 is a call flow diagram illustrating example operations for RACH resource allocation, in accordance with certain aspects of the present disclosure.

FIG. 9 is a flow diagram illustrating example operations for wireless communication by a base station, in accordance with certain aspects of the present disclosure.

FIG. 10 is a flow diagram illustrating example operations for wireless communication by a user equipment, in accordance with certain aspects of the present disclosure.

FIG. 11 is a call flow diagram illustrating example operations for RACH resource allocation, in accordance with certain aspects of the present disclosure.

FIG. 12 depicts aspects of an example communications device.

FIG. 13 depicts aspects of an example communications device.

### DETAILED DESCRIPTION

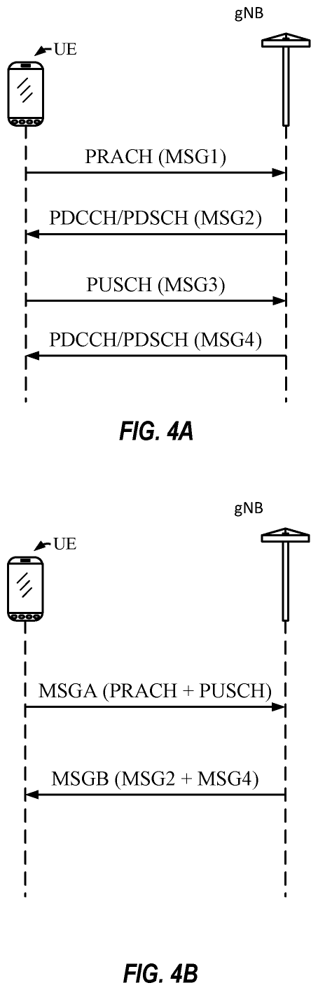

Aspects of the present disclosure provide apparatuses, methods, processing systems, and computer-readable mediums for random access channel (RACH) communication. In some implementations, reduced capability (RedCap) UEs and coverage enhanced (CovEnh) UEs may use separate RACH resources different from legacy UEs to indicate reduced UE capabilities or repetition preferences. As used herein, a RedCap UE generally refers to a UE supporting a set of capabilities, such as support for a reduced bandwidth configuration, reduced receiver configuration, and half-duplex (HD) operation. A CovEnh UE generally refers to a UE supporting a set of capabilities, such as support for RACH procedure message repetition (e.g., repetition of MSG3 or MSG4 of a RACH procedure described with respect to FIG. 4A). Some UEs may be able only to support the capabilities for RedCap UEs, and thus, may be referred to as RedCap-only UEs. Some UEs may be able only to support the capabilities for CovEnh UEs, and thus, may be referred to as CovEnh-only UEs. UEs that are able to support both capabilities for RedCap and CovEnh UEs may be referred to as RedCap and CovEnh UEs.

Using separate RACH resources for either RedCap UE indication or CovEnh UE repetition preference may cause RACH resource blockage (e.g., interference) for legacy UEs that use separate RACH resources. In some aspects of the present disclosure, RACH resources for RedCap UEs and CovEnh UEs may be at least partially shared, reducing RACH resource blockage for legacy UEs. Moreover, using the partially shared resources may cause ambiguity at a base station with regards to the type of UE that is transmitting a RACH message. Some aspects provide configuration frameworks and UE behaviors to avoid such ambiguity at the BS.

### Introduction to Wireless Communication Networks

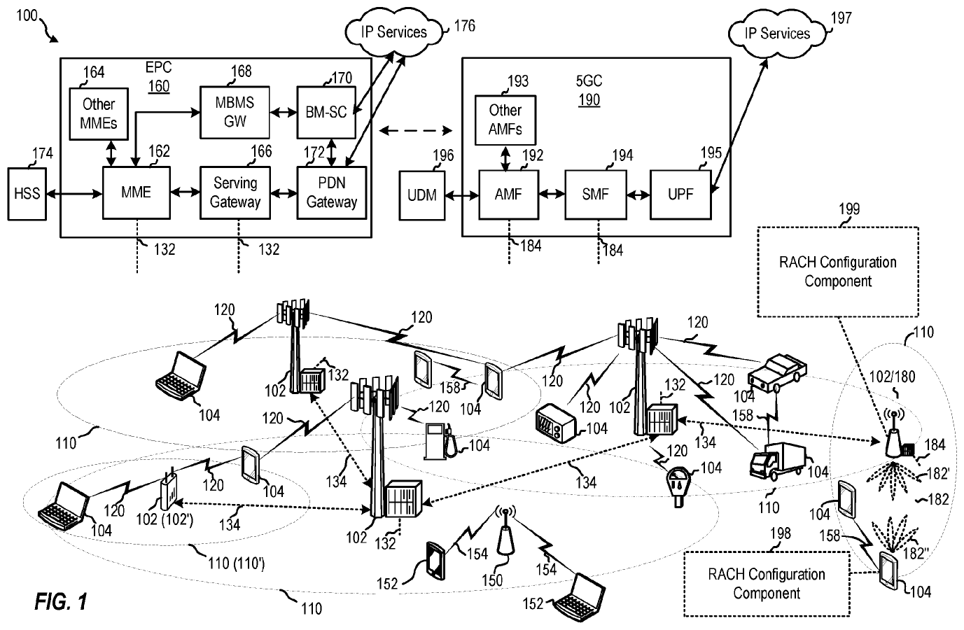

FIG. 1 depicts an example of a wireless communications system 100, in which aspects described herein may be implemented.

Generally, wireless communications system 100 includes base stations (BSs) 102, user equipments (UEs) 104, one or more core networks, such as an Evolved Packet Core (EPC) 160 and 5G Core (5GC) network 190, which interoperate to provide wireless communications services.

Base stations 102 may provide an access point to the EPC 160 and/or 5GC 190 for a user equipment 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. Base stations may include and/or be referred to as a gNB, NodeB, eNB, ng-eNB (e.g., an eNB that has been enhanced to provide connection to both EPC 160 and 5GC 190), an access point, a base transceiver station, a radio base station, a radio transceiver, or a transceiver function, or a transmission reception point in various contexts.

Base stations 102 wirelessly communicate with UEs 104 via communications links 120. Each of base stations 102 may provide communication coverage for a respective geographic coverage area 110, which may overlap in some cases. For example, small cell 102′ (e.g., a low-power base station) may have a coverage area 110′ that overlaps the coverage area 110 of one or more macrocells (e.g., high-power base stations).

The communication links 120 between base stations 102 and UEs 104 may include uplink (UL) (also referred to as reverse link) transmissions from a user equipment 104 to a base station 102 and/or downlink (DL) (also referred to as forward link) transmissions from a base station 102 to a user equipment 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, base station 180 and the UE 104 may each include a plurality of antennas, such as antenna elements, antenna panels, and/or antenna arrays to facilitate the beamforming.

In some cases, base station 180 may transmit a beamformed signal to UE 104 in one or more transmit directions 182′. UE 104 may receive the beamformed signal from the base station 180 in one or more receive directions 182″. UE 104 may also transmit a beamformed signal to the base station 180 in one or more transmit directions 182″. Base station 180 may also receive the beamformed signal from UE 104 in one or more receive directions 182′. Base station 180 and UE 104 may then perform beam training to determine the best receive and transmit directions for each of base station 180 and UE 104. Notably, the transmit and receive directions for base station 180 may or may not be the same. Similarly, the transmit and receive directions for UE 104 may or may not be the same.

Wireless communication network 100 includes RACH configuration 199, which may be configured to transmit RACH resources. Wireless network 100 further includes RACH configuration 198, which may be used configured to receive RACH resources.

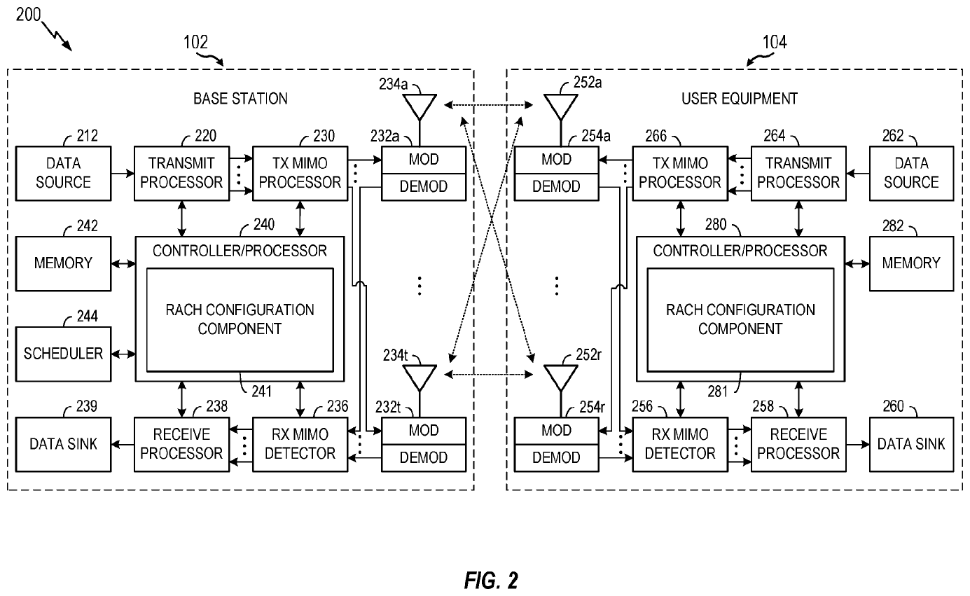

FIG. 2 depicts aspects of an example base station (BS) 102 and a user equipment (UE) 104.

Generally, base station 102 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, base station 102 may send and receive data between itself and user equipment 104.

Base station 102 includes controller/processor 240, which may be configured to implement various functions related to wireless communications. In the depicted example, controller/processor 240 includes RACH configuration 241, which may be representative of RACH configuration 199 of FIG. 1. Notably, while depicted as an aspect of controller/processor 240, RACH configuration 241 may be implemented additionally or alternatively in various other aspects of base station 102 in other implementations.

Generally, user equipment 104 includes various processors (e.g., 258, 264, 266, and 280), antennas 252a-r (collectively 252), transceivers 254a-r (collectively 254), which include modulators and demodulators, and other aspects, which enable wireless transmission of data (e.g., data source 262) and wireless reception of data (e.g., data sink 260).

User equipment 104 includes controller/processor 280, which may be configured to implement various functions related to wireless communications. In the depicted example, controller/processor 280 includes RACH configuration 281, which may be representative of RACH configuration 198 of FIG. 1. Notably, while depicted as an aspect of controller/processor 280, RACH configuration 281 may be implemented additionally or alternatively in various other aspects of user equipment 104 in other implementations.

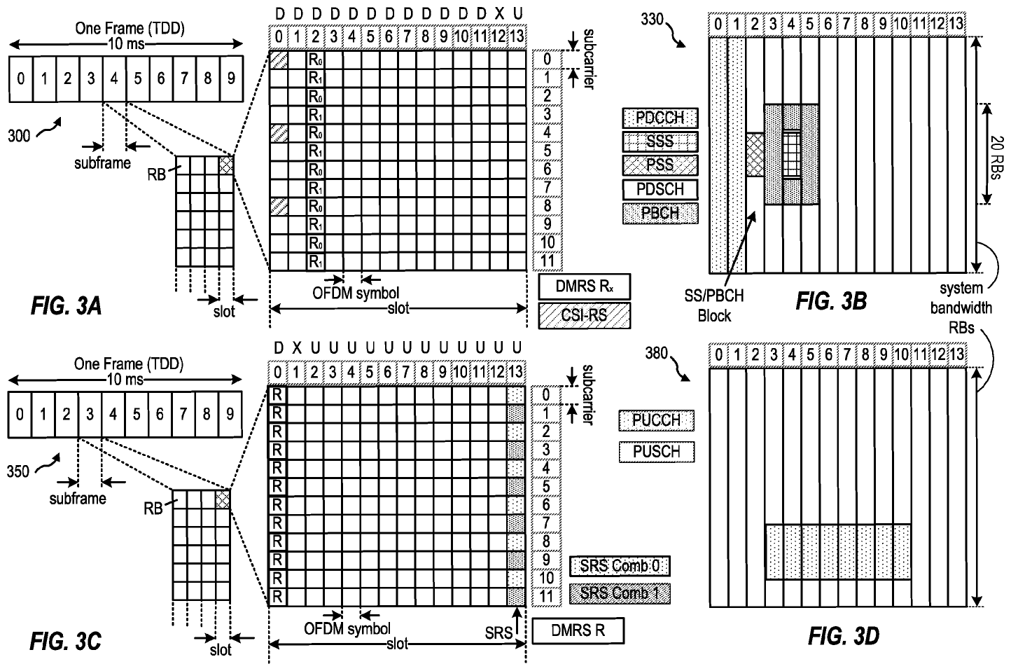

FIGS. 3A-3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe.

Further discussions regarding FIG. 1, FIG. 2, and FIGS. 3A-3D are provided later in this disclosure.

### Introduction to Random Access Channel (RACH)

FIG. 4A is a timing (or “call-flow”) diagram illustrating an example four-step RACH procedure, in accordance with certain aspects of the present disclosure. A first message (MSG1) may be sent from the UE to a BS (gNB) on the physical random access channel (PRACH). In this case, MSG1 may only include a RACH preamble. The gNB may respond with a random access response (RAR) message (MSG2) which may include the identifier (ID) of the RACH preamble, a timing advance (TA), an uplink grant, cell radio network temporary identifier (C-RNTI), and a back off indicator. MSG2 may include a physical downlink control channel (PDCCH) communication including control information for a following communication on the physical downlink shared channel (PDSCH), as illustrated. In response to MSG2, a third message (MSG3) is transmitted from the UE to the gNB on the physical uplink shared channel (PUSCH). MSG3 may include one or more of a RRC connection request, a tracking area update request, a system information request, a positioning fix or positioning signal request, or a scheduling request. The gNB then responds with a fourth message (MSG4) which may include a contention resolution message.

In some cases, to speed up access, a two-step RACH procedure may be supported. As the name implies, the two-step RACH procedure may effectively “collapse” the four messages of the four-step RACH procedure into two messages.

FIG. 4B is a timing diagram illustrating an example two-step RACH procedure, in accordance with certain aspects of the present disclosure. A first enhanced message (msgA) may be sent from the UE to the gNB. In certain aspects, msgA includes some or all the information from MSG1 and MSG3 from the four-step RACH procedure, effectively combining MSG1 and MSG3. For example, msgA may include MSG1 and MSG3 multiplexed together such as using one of time-division multiplexing or frequency-division multiplexing. In certain aspects, msgA includes a RACH preamble for random access and a payload. The msgA payload, for example, may include the UE-ID and other signaling information (e.g., buffer status report (BSR)) or scheduling request (SR). The gNB may respond with a RAR message (msgB) which may effectively combine MSG2 and MSG4 described above. For example, msgB may include the ID of the RACH preamble, a timing advance (TA), a back off indicator, a contention resolution message, UL/DL grant, and transmit power control (TPC) commands.

For a four-step RACH procedure (e.g., as described with respect to FIG. 4A), an indication that a UE is a reduced capability (RedCap) UE is supported using at least MSG1. The indication in MSG1 can be configured to be enabled/disabled. Moreover, some implementations use techniques for coverage enhancement. For example, MSG1 may be used for requesting MSG3 PUSCH repetition or indicating a repetition preference.

A separate preamble with a shared random access occasion (RO) configured by the same physical random access channel (PRACH) configuration index with legacy UEs may be used for such a request. A RO generally refers to a configured time period during which a RACH message may be transmitted. In some implementations, a PRACH mask may be used to indicate a sub-set of ROs associated with the same synchronization signal block (SSB) index within an SSB-RO mapping cycle for requesting MSG3 repetition for a UE. A shared RO may be an RO with preamble(s) for four-step RACH only or with preambles for both four-step RACH and two-step RACH. In some cases, a separate RO may be configured by a separate PRACH configuration index from legacy UEs. In some implementations, a separate RO may be used, which includes: (1) the separate RO configured by a separate RACH configuration index from legacy UE, and (2) the remaining RO (if any) configured by the same PRACH configuration index with legacy UEs, that legacy UEs cannot use for PRACH transmission.

A shared RO is configured by the same PRACH configuration index with legacy UEs in some implementations. Therefore, such resources may be used for existing procedures (e.g., RO for four-step RACH only or RO for two-step RACH only or both). Hence, it is important to define a shared RO for a UE to request MSG3 repetition (or indicate that the UE is a RedCap UE). The shared RO for requesting MSG3 PUSCH repetition can be an RO with preamble(s) for four-step RACH only or an RO with preambles for both four-step RACH and two-step RACH. Whether an RO with preamble(s) for four-step RACH only or an RO with preambles for both four-step RACH and two-step RACH is used can be indicated to the UE. A separate RO for repetition requests may also be used in some cases. If a separate RO for a repetition request is used, this separate RO may also be used for other procedures (e.g., RedCap identification in MSG1, as described). If a separate RO indicates the MSG3 PUSCH repetition request, Redcap UE may share the RO to send the identification via PRACH.

### Aspects Related to Reduction of Blockage and Ambiguity Avoidance

Using separate RACH resources for either RedCap UE indication or for repetition (e.g., MSG2, MSG3, or MSG4-repetition) indication for coverage enhanced (CovEnh) UEs may cause additional RACH resource blockage for legacy UEs, as described herein. If RedCap UEs and CovEnh UEs use separate RACH resources, this problem is even more severe. Thus, certain aspects use RACH resource sharing between RedCap UEs and CovEnh UEs. This is reasonable as RedCap UEs may include smaller form factors and/or use less transmit antenna gain, and thus, it may be easier for RedCap UEs to compensate for coverage loss issues. Thus, partially overlapped RACH resources may be used. For example, RACH-resource-A may be configured for RedCap UEs, RACH-resource-B may be configured for CovEnh UEs, and RACH-resource-C may be configured for RedCap and CovEnh UEs, where RACH-resource-C includes the overlapping resources of RACH-resource-A and RACH-resource-B. However, since some UEs may have capabilities associated with RedCap and CovEnh UEs, the different kinds of UEs (RedCap-only UEs, CovEnh-only UEs, RedCap and CovEnh UEs) may identify the different RACH resources. Without further enhancement on configuration framework or UE behavior (assuming there is only RACH configurations for RedCap UEs and CovEnh UEs), a RedCap-only UE sending out RACH in RACH-resource-C may cause ambiguity, as the BS may configure repetitions which the RedCap-only UE does not support.

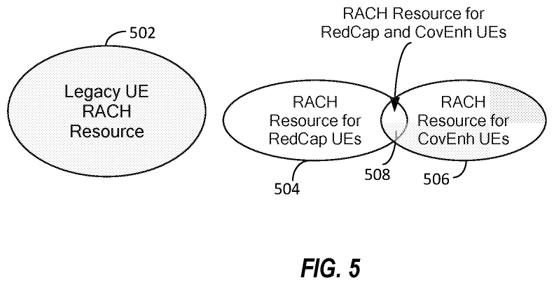

FIG. 5 illustrates RACH resources for legacy UEs, RedCap UEs, and CovEnh UEs, in accordance with certain aspects of the present disclosure. As shown, a first set of RACH resources 504 may be assigned for RedCap UEs, and a second set of RACH resources 506 may be assigned for CovEnh UEs. The first and second set of resources may include overlapping resources. A third set of RACH resources 508 for UEs supporting both RedCap and CovEnh capabilities (referred to as RedCap and CovEnh UEs) may include the overlapping resources (e.g., in time and frequency). As shown, the first set of RACH resources 504 and the second set of RACH resources 506 may be separate from legacy UE RACH resources 502 (e.g., UEs associated release-16 of the 3GPP standard), reducing RACH resource blockage of legacy UEs as described herein.

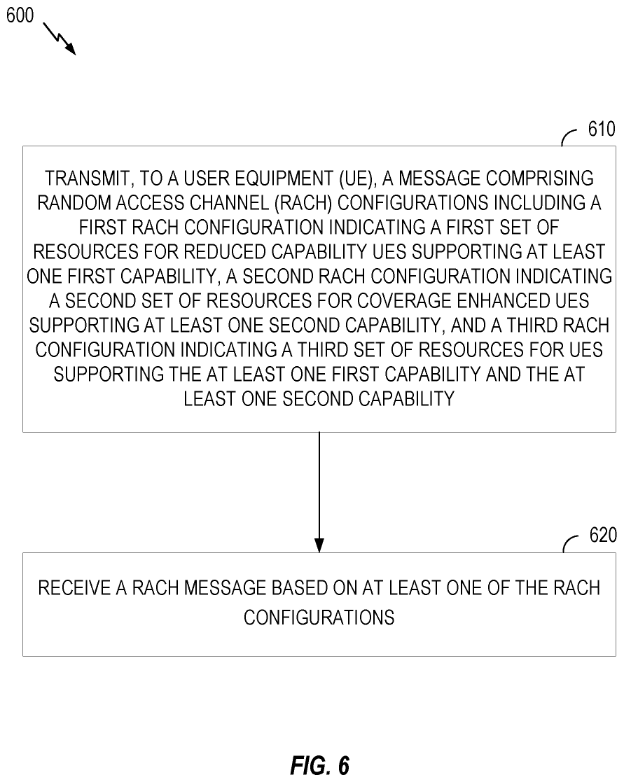

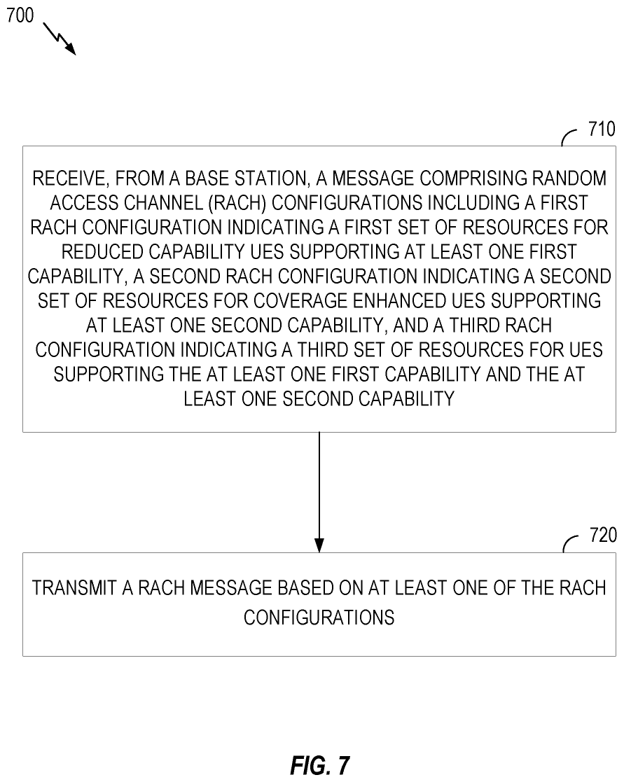

Some aspects provide techniques that enable different kinds of UEs (e.g., RedCap only UEs, CovEnh only UEs, RedCap and CovEnh UEs) to identify the difference among the associated resources. Some aspects also provide UE behaviors to reduce ambiguity by a BS regarding the supported capability of a UE. For example, as described, if a BS provides only RACH configurations for RedCap UEs and CovEnh UEs, a RedCap-only UE (or CovEnh UE) sending out a RACH message using the overlapping resources may cause ambiguity by the BS (e.g., resulting in the BS configuring repetitions which is not supported by the RedCap-only UE). In some aspects, a BS may provide a separate configuration for each of RACH resources 504, RACH resources 506, and RACH resources 508, avoiding such ambiguity at the BS, as described in more detail with respect to FIGS. 6 and 7.

FIG. 6 is a flow diagram illustrating example operations 600 for wireless communication, in accordance with certain aspects of the present disclosure. The operations 600 may be performed, for example, by a BS (e.g., such as the BS 102 in the wireless communication network 100 of FIG. 1).

Operations 600 may be implemented as software components that are executed and run on one or more processors (e.g., controller/processor 240 of FIG. 2). Further, the transmission and reception of signals by the BS in operations 600 may be enabled, for example, by one or more antennas (e.g., antennas 234 of FIG. 2). In certain aspects, the transmission and/or reception of signals by the BS may be implemented via a bus interface of one or more processors (e.g., controller/processor 240 or sidelink configuration component 241 of FIG. 2) obtaining and/or outputting signals.

The operations 600 begin, at block 610, with the BS transmitting, to a user equipment (UE), a message comprising random access channel (RACH) configurations including a first RACH configuration indicating a first set of resources (e.g., the first set of RACH resources 504) for reduced capability UEs supporting at least one first capability, a second RACH configuration indicating a second set of resources (e.g., the second set of RACH resources 506) for coverage enhanced UEs supporting at least one second capability, and a third RACH configuration indicating a third set of resources (e.g., the third set of RACH resources 508) for UEs supporting the at least one first capability and the at least one second capability. For example, the first set of resources and the second set of resources may include overlapping resources, and the third set of resources may include the overlapping resources. At block 620, the BS may receive a RACH message based on at least one of the RACH configurations.

FIG. 7 is a flow diagram illustrating example operations 700 for wireless communication, in accordance with certain aspects of the present disclosure. The operations 700 may be performed, for example, by a first wireless node, such as a UE (e.g., a UE 104 in the wireless communication network 100 of FIG. 1). The UE may be a RedCap UE, a CovEnh UE, or a RedCap and CovEnh UE.

Operations 700 may be implemented as software components that are executed and run on one or more processors (e.g., controller/processor 280 of FIG. 2). Further, the transmission and reception of signals by the UE in operations 700 may be enabled, for example, by one or more antennas (e.g., antennas 252 of FIG. 2). In certain aspects, the transmission and/or reception of signals by the UE may be implemented via a bus interface of one or more processors (e.g., controller/processor 280 or sidelink configuration component 281 of FIG. 2) obtaining and/or outputting signals.

The operations 700 begin, at block 710, with the UE receiving, from a base station, a message comprising RACH configurations including a first RACH configuration indicating a first set of resources (e.g., the first set of RACH resources 504) for reduced capability UEs supporting at least one first capability, a second RACH configuration indicating a second set of resources (e.g., the second set of RACH resources 506) for coverage enhanced UEs supporting at least one second capability, and a third RACH configuration indicating a third set of resources (e.g., the third set of RACH resources 508) for UEs supporting the at least one first capability and the at least one second capability. For example, the first set of resources and the second set of resources may include overlapping resources, and the third set of resources may include the overlapping resources (e.g., in time and frequency).

At block 720, the UE transmits a RACH message based on at least one of the RACH configurations. For example, transmitting the RACH message may include transmitting an indication that the UE is a reduced capability UE. As another example, transmitting the RACH message may include transmitting an indication associated with repetition of a RACH procedure message (e.g., repetition of MSG2, MSG3, or MSG4). For example, the indication associated with the repetition may include a coverage enhanced repetition capability or preference.

In some aspects, the reduced capability UEs supporting the at least one first capability include UEs supporting at least one of a reduced bandwidth configuration, reduced receiver configuration, or half duplex (HD) frequency division duplexing (FDD). In other aspects, the coverage enhanced UEs supporting the at least one second capability comprise UEs supporting at least one of message 2 (MSG-2) physical downlink control channel (PDCCH) or physical downlink shared channel (PDSCH) repetition, message 3 (MSG-3) physical uplink shared channel (PUSCH) repetition, or message 4 (MSG-4) PDCCH, PDSCH, or PUSCH repetition. In some aspects, the first set of resources, the second set of resources, or the third set of resources includes at least one random access occasion (RO) (e.g., a time period configured for RACH communication) to be used for transmitting the RACH message, or a preamble to be used for transmitting the RACH message.

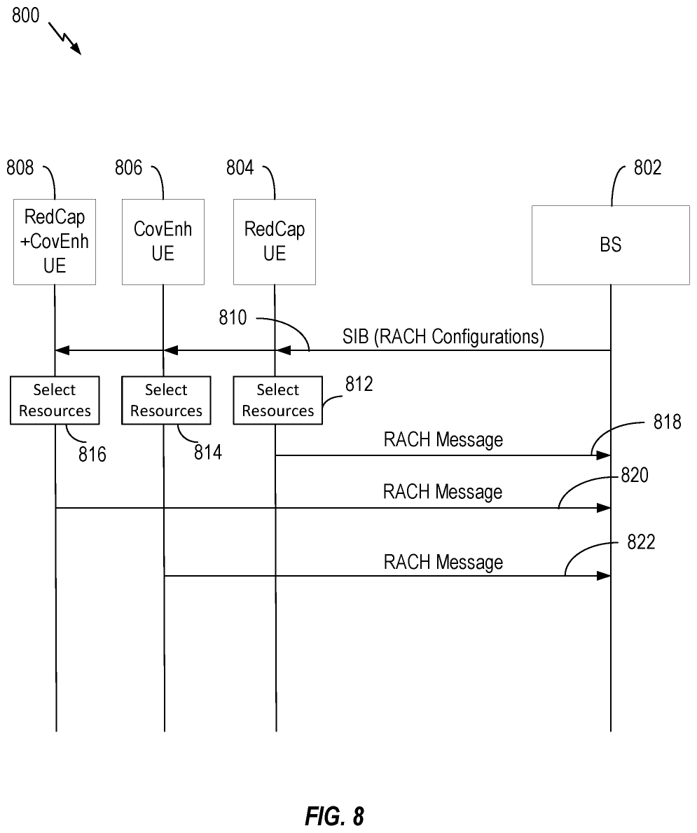

FIG. 8 is a call flow diagram illustrating example operations 800 for RACH resource allocation, in accordance with certain aspects of the present disclosure. In some aspects, RACH resources are configured in a system information block (e.g., SIB1) for RedCap UE capability indication and for CovEnh repetition capability/preference indication. As described, the RACH resources for the RedCap UEs and CovEnh UEs may be at least partially overlapped. For example, the BS 802 may transmit a SIB message 810 including RedCap-only RACH resources (e.g., the first set of RACH resources 504), CovEnh-only RACH resources (e.g., the second set of RACH resources 506), and RedCap and CovEnh RACH resources (e.g., the third set of RACH resources 508) within separate information elements (IEs) in the SIB message for RACH resources. As shown, the SIB message may be received by a RedCap UE 804, CovEnh UE 806, and/or RedCap and CovEnh UE 808. Each of the UEs 804, 806, 808 may select, at respective blocks 812, 814, 816, resources for transmission of a RACH message. For example, the RedCap UE 804 may select the RedCap-only RACH resources, the CovEnh UE 806 may select the CovEnh-only RACH resources, and the RedCap and CovEnh UE 808 may select the RedCap and CovEnh RACH resources. As shown, each of UEs 804, 806, 808 may transmit respective RACH messages 818, 820, 822 using the associated resources that are selected.

In some aspects, the BS may only configure resources for RedCap UEs and CovEnh UEs. As described, if only RACH configurations for RedCap UEs and CovEnh UEs is provided by a BS, a RedCap-only UE (or CovEnh UE) sending out a RACH message using the overlapping resources may cause ambiguity by the BS (e.g., resulting in the BS providing a configuration which the RedCap-only UE (or CovEnh UE) does not support). Thus, some aspects provide UE behaviors and RACH resource configuration frameworks, reducing the RACH resource blockage to legacy UEs and reducing potential ambiguities among different UE capabilities.

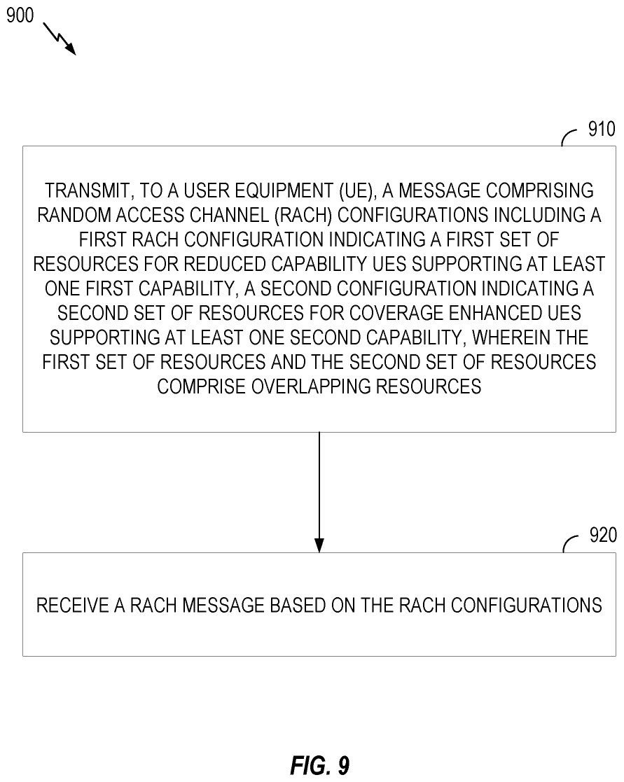

FIG. 9 is a flow diagram illustrating example operations 900 for wireless communication, in accordance with certain aspects of the present disclosure. The operations 900 may be performed, for example, by a wireless node, such as a BS (e.g., such as the BS 102 in the wireless communication network 100 of FIG. 1).

Operations 900 may be implemented as software components that are executed and run on one or more processors (e.g., controller/processor 240 of FIG. 2). Further, the transmission and reception of signals by the BS in operations 600 may be enabled, for example, by one or more antennas (e.g., antennas 234 of FIG. 2). In certain aspects, the transmission and/or reception of signals by the BS may be implemented via a bus interface of one or more processors (e.g., controller/processor 240 or sidelink configuration component 241 of FIG. 2) obtaining and/or outputting signals.

The operations 900 begin, at block 910, with the BS transmitting, to a base station (BS) transmitting, to a UE, a message comprising RACH configurations including a first RACH configuration indicating a first set of resources for reduced capability UEs supporting at least one first capability, a second configuration indicating a second set of resources for coverage enhanced UEs supporting at least one second capability, wherein the first set of resources and the second set of resources comprise overlapping resources. At block 920, the BS receives a RACH message based on the RACH configurations.

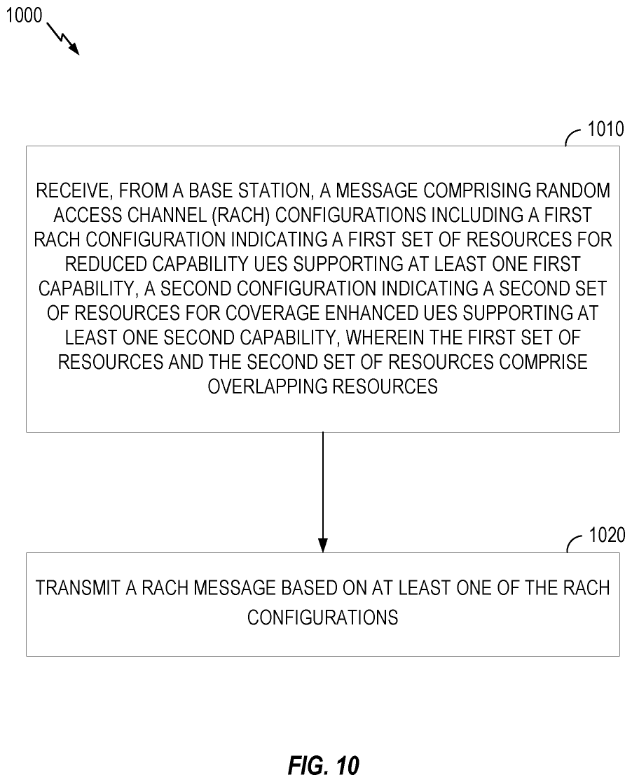

FIG. 10 is a flow diagram illustrating example operations 1000 for wireless communication, in accordance with certain aspects of the present disclosure. The operations 1000 may be performed, for example, by a first wireless node, such as a UE (e.g., a UE 104 in the wireless communication network 100 of FIG. 1). The UE may be a RedCap UE, a CovEnh UE, or a RedCap and CovEnh UE.

Operations 1000 may be implemented as software components that are executed and run on one or more processors (e.g., controller/processor 280 of FIG. 2). Further, the transmission and reception of signals by the UE in operations 1000 may be enabled, for example, by one or more antennas (e.g., antennas 252 of FIG. 2). In certain aspects, the transmission and/or reception of signals by the UE may be implemented via a bus interface of one or more processors (e.g., controller/processor 280 or sidelink configuration component 281 of FIG. 2) obtaining and/or outputting signals.

The operations 1000 begin, at block 1010, with the UE receiving, from a base station, a message comprising random access channel (RACH) configurations including a first RACH configuration indicating a first set of resources for reduced capability UEs supporting at least one first capability, a second configuration indicating a second set of resources for coverage enhanced UEs supporting at least one second capability, where the first set of resources and the second set of resources comprise overlapping resources. At block 1020, the UE transmits a RACH message based on the RACH configurations. In some aspects, transmitting the RACH message based on the RACH configurations includes avoiding transmission of the RACH message using the overlapping resources.

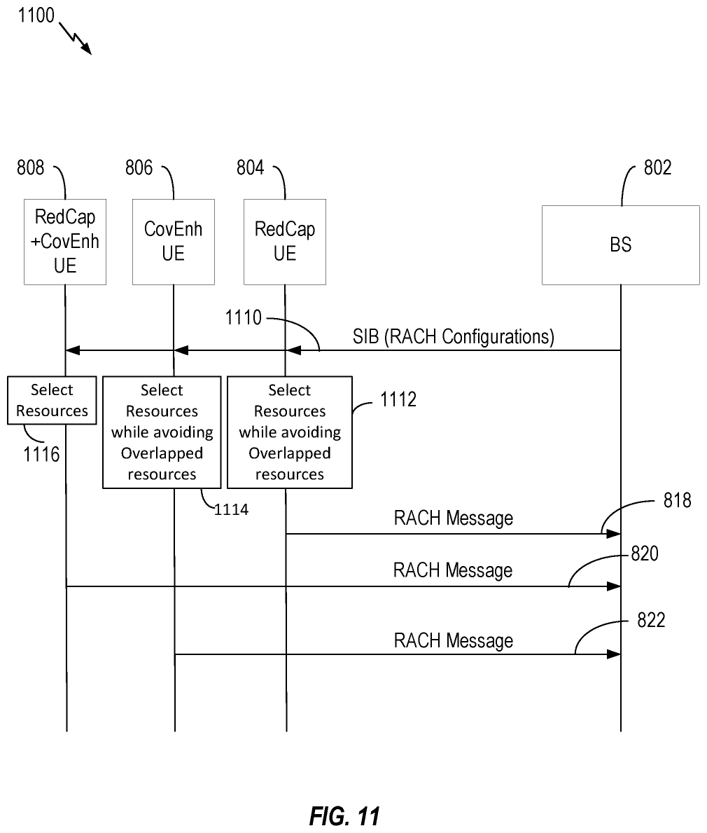

FIG. 11 is a call flow diagram illustrating example operations 1100 for RACH resource allocation, in accordance with certain aspects of the present disclosure. In some aspects, only RedCap RACH resources and CovEnh RACH resources are explicitly configured in SIB1, as described. For example, the BS 802 may transmit a SIB message 1110 including RedCap-only RACH resources and CovEnh-only RACH resources.

Based on the BS configurations in SIB, certain UE behaviors may be implemented to avoid BS ambiguity as described herein. For example, in addition to identifying the RACH resources dedicated for RedCap UEs, both RedCap-only UEs (e.g., RedCap UE 804) and RedCap and CovEnh UEs (e.g., UE 808) may identify the RACH resources dedicated for RedCap and CovEnh purposes (e.g., may identify the third set of resources 508), based on the RACH resources configured for RedCap UEs and for CovEnh UEs by the BS in message 1110. The RedCap-only UEs may avoid using the RACH resources dedicated for RedCap and CovEnh UEs. For example, at block 1112, the RedCap UE 804 may select resources for transmission of RACH message 818 while avoiding the overlapping resources (e.g., the third set of resources 508), such that BS ambiguity with regards to whether the UE is a RedCap UE or a RedCap and CovEnh UE is avoided. RedCap and CovEnh UE 808 may transmit a RACH message 820 using the third set of resources 508, as selected at block 1116.

Similarly, in addition to identifying the RACH resources dedicated for CovEnh UEs, both CovEnh-only UEs and RedCap and CovEnh UEs may identify the RACH resources dedicated for RedCap and CovEnh purposes, based on the RACH resources configured for RedCap UEs and for CovEnh UEs by the BS. Thus, CovEnh-only UEs may avoid using the RACH resources dedicated for RedCap and CovEnh UEs. For example, the CovEnh UE 806 may select, at block 1114, resources for transmission of RACH message 822 while avoiding the overlapping resources (e.g., the third set of resources 508). In this manner, BS ambiguity may be avoided since RedCap-only UEs and CovEnh-only UEs avoid using the overlapping resources.

As described herein, RedCap and CovEnh can be different UE capability sets including one or more sub-capabilities. For example, capabilities for RedCap UEs may include at least one of reduced BW, reduced number of receivers, or support for half duplex (HD)-frequency division duplexing (FDD), to name a few. HD FDD generally refers to a configuration where a UE can only receive (or transmit) at any particular point in time. CovEnh capabilities include at least one of MSG2 PDCCH/PDSCH repetition, MSG3 PUSCH repetition, MSG4 PDCCH/PDSCH/PUCCH repetition, etc. Moreover, the RACH resources configured by the BS via messages 810 and 1110 may include at least random access occasions (ROs) and preambles to be used for RACH transmissions using the respective resources.

### Example Wireless Communication Devices

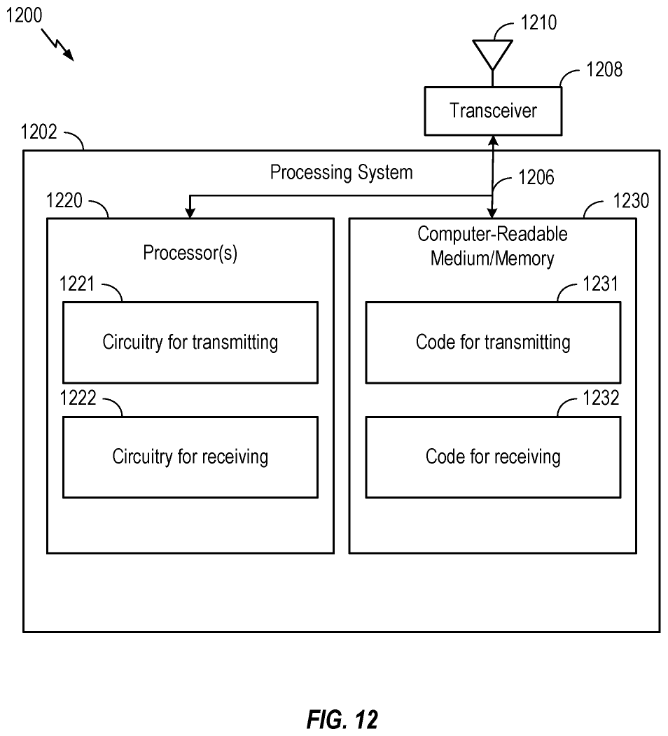

FIG. 12 depicts an example communications device 1200 that includes various components operable, configured, or adapted to perform operations for the techniques disclosed herein, such as the operations depicted and described with respect to FIGS. 6 and 9. In some examples, communication device 1200 may be a base station 102 as described, for example with respect to FIGS. 1 and 2.

Communications device 1200 includes a processing system 1202 coupled to a transceiver 1208 (e.g., a transmitter and/or a receiver). Transceiver 1208 is configured to transmit (or send) and receive signals for the communications device 1200 via an antenna 1210, such as the various signals as described herein. Processing system 1202 may be configured to perform processing functions for communications device 1200, including processing signals received and/or to be transmitted by communications device 1200.

Processing system 1202 includes one or more processors 1220 coupled to a computer-readable medium/memory 1230 via a bus 1206. In certain aspects, computer-readable medium/memory 1230 is configured to store instructions (e.g., computer-executable code) that when executed by the one or more processors 1220, cause the one or more processors 1220 to perform the operations illustrated in FIGS. 6 and 9, or other operations for performing the various techniques discussed herein for transmitting RACH resources.

In the depicted example, computer-readable medium/memory 1230 stores code 1231 for transmitting, and code 1232 for receiving.

In the depicted example, the one or more processors 1220 include circuitry configured to implement the code stored in the computer-readable medium/memory 1230, including circuitry 1221 for transmitting, and circuitry 1222 for receiving.

Various components of communications device 1200 may provide means for performing the methods described herein, including with respect to FIGS. 6 and 9.

In some examples, means for transmitting or sending (or means for outputting for transmission) may include the transceivers 232 and/or antenna(s) 234 of the base station 102 illustrated in FIG. 2 and/or transceiver 1208 and antenna 1210 of the communication device 1200 in FIG. 12.

In some examples, means for receiving (or means for obtaining) may include the transceivers 232 and/or antenna(s) 234 of the base station illustrated in FIG. 2 and/or transceiver 1208 and antenna 1210 of the communication device 1200 in FIG. 12.

In some examples, means for transmitting and means for receiving may include various processing system components, such as: the one or more processors 1220 in FIG. 12, or aspects of the base station 102 depicted in FIG. 2, including receive processor 238, transmit processor 220, TX MIMO processor 230, and/or controller/processor 240 (including RACH configuration 241).

Notably, FIG. 12 is an example, and many other examples and configurations of communication device 1200 are possible.

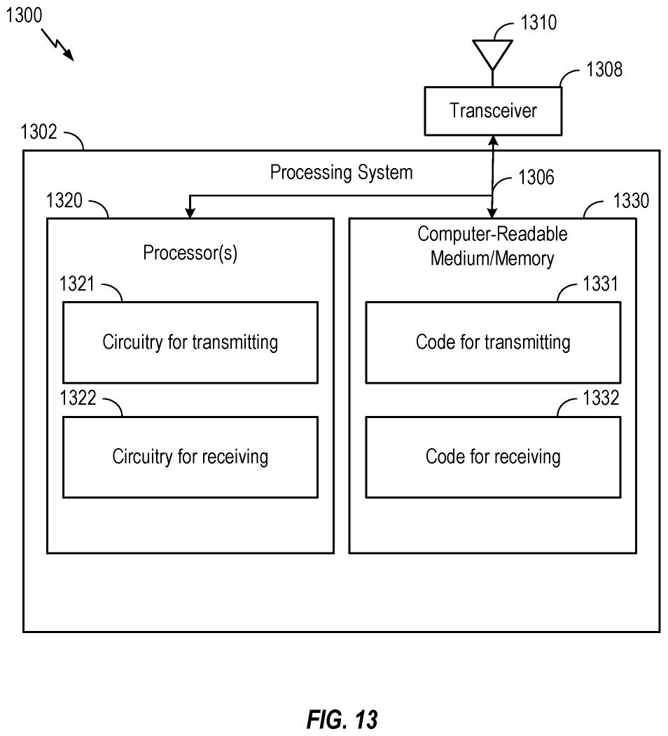

FIG. 13 depicts an example communications device 1300 that includes various components operable, configured, or adapted to perform operations for the techniques disclosed herein, such as the operations depicted and described with respect to FIGS. 7 and 10. In some examples, communication device 1300 may be a user equipment 104 as described, for example with respect to FIGS. 1 and 2.

Communications device 1300 includes a processing system 1302 coupled to a transceiver 1308 (e.g., a transmitter and/or a receiver). Transceiver 1308 is configured to transmit (or send) and receive signals for the communications device 1300 via an antenna 1310, such as the various signals as described herein. Processing system 1302 may be configured to perform processing functions for communications device 1300, including processing signals received and/or to be transmitted by communications device 1300.

Processing system 1302 includes one or more processors 1320 coupled to a computer-readable medium/memory 1330 via a bus 1306. In certain aspects, computer-readable medium/memory 1330 is configured to store instructions (e.g., computer-executable code) that when executed by the one or more processors 1320, cause the one or more processors 1320 to perform the operations illustrated in FIGS. 7 and 10, or other operations for performing the various techniques discussed herein for receiving RACH resources.

In the depicted example, computer-readable medium/memory 1330 stores code 1331 for transmitting, and code 1332 for receiving.

In the depicted example, the one or more processors 1320 include circuitry configured to implement the code stored in the computer-readable medium/memory 1330, including circuitry 1321 for transmitting, and circuitry 1322 for receiving.

Various components of communications device 1300 may provide means for performing the methods described herein, including with respect to FIGS. 7 and 10.

In some examples, means for transmitting or sending (or means for outputting for transmission) may include the transceivers 254 and/or antenna(s) 252 of the user equipment 104 illustrated in FIG. 2 and/or transceiver 1308 and antenna 1310 of the communication device 1300 in FIG. 13.

In some examples, means for receiving (or means for obtaining) may include the transceivers 254 and/or antenna(s) 252 of the user equipment 104 illustrated in FIG. 2 and/or transceiver 1308 and antenna 1310 of the communication device 1300 in FIG. 13.

In some examples, means for transmitting and means for receiving may include various processing system components, such as: the one or more processors 1320 in FIG. 13, or aspects of the user equipment 104 depicted in FIG. 2, including receive processor 258, transmit processor 264, TX MIMO processor 266, and/or controller/processor 280 (including RACH configuration 281).

Notably, FIG. 13 is an example, and many other examples and configurations of communication device 1300 are possible.

### Example Clauses

Implementation examples are described in the following numbered clauses:

Clause 1. A method for wireless communication by a user equipment (UE), comprising: receiving, from a base station, a message comprising random access channel (RACH) configurations including a first RACH configuration indicating a first set of resources for reduced capability UEs supporting at least one first capability, a second RACH configuration indicating a second set of resources for coverage enhanced UEs supporting at least one second capability, and a third RACH configuration indicating a third set of resources for UEs supporting the at least one first capability and the at least one second capability; and transmitting a RACH message based on at least one of the RACH configurations.

Clause 2. The method of clause 1, wherein the first set of resources and the second set of resources comprise overlapping resources, and wherein the third set of resources comprises the overlapping resources.

Clause 3. The method of clause 2, wherein the first set of resources and the second set of resources comprise overlapping resources in time and frequency.

Clause 4. The method of any one of clauses 1-3, wherein transmitting the RACH message comprises transmitting an indication that the UE is a reduced capability UE.

Clause 5. The method of any one of clauses 1-4, wherein transmitting the RACH message comprises transmitting an indication associated with repetition of a RACH procedure message.

Clause 6. The method of clause 5, wherein the indication associated with the repetition includes a coverage enhanced repetition capability or preference.

Clause 7. The method of any one of clauses 1-6, wherein the reduced capability UEs supporting the at least one first capability include UEs supporting at least one of a reduced bandwidth configuration, reduced receiver configuration, or half duplex (HD) frequency division duplexing (FDD).

Clause 8. The method of any one of clauses 1-7, wherein the coverage enhanced UEs supporting the at least one second capability comprise UEs supporting at least one of message 2 (MSG-2) physical downlink control channel (PDCCH) or physical downlink shared channel (PDSCH) repetition, message 3 (MSG-3) physical uplink shared channel (PUSCH) repetition, or message 4 (MSG-4) PDCCH, PDSCH, or PUSCH repetition.

Clause 9. The method of any one of clauses 1-8, wherein the first set of resources, the second set of resources, or the third set of resources includes at least one random access occasion (RO) to be used for transmitting the RACH message, or a preamble to be used for transmitting the RACH message.

Clause 10. A method for wireless communication by a user equipment (UE), comprising: receiving, from a base station, a message comprising random access channel (RACH) configurations including a first RACH configuration indicating a first set of resources for reduced capability UEs supporting at least one first capability, a second configuration indicating a second set of resources for coverage enhanced UEs supporting at least one second capability, wherein the first set of resources and the second set of resources comprise overlapping resources; and transmitting a RACH message based on the RACH configurations.

Clause 11. The method of clause 10, wherein the first set of resources and the second set of resources comprise overlapping resources in time and frequency.

Clause 12. The method of any one of clauses 10-11, wherein transmitting the RACH message based on the RACH configurations includes avoiding transmission of the RACH message using the overlapping resources.

Clause 13. The method of any one of clauses 10-12, wherein the at least one first capability is associated with reduced capability UEs, and wherein the at least one second capability is associated with coverage enhanced UEs.

Clause 14. The method of any one of clauses 10-13, wherein transmitting the RACH message comprises transmitting an indication that the UE is a reduced capability UE.

Clause 15. The method of any one of clauses 10-14, wherein transmitting the RACH message comprises transmitting an indication associated with repetition of a RACH procedure message.

Clause 16. The method of clause 15, wherein the indication associated with the repetition includes a coverage enhanced repetition capability or preference.

Clause 17. The method of any one of clauses 10-16, wherein the reduced capability UEs supporting the at least one first capability comprise UEs supporting at least one of a reduced bandwidth configuration, reduced receiver configuration, or half duplex (HD) frequency division duplexing (FDD).

Clause 18. The method of any one of clauses 10-17, wherein the coverage enhanced UEs supporting the at least one second capability includes UEs supporting at least one of message 2 (MSG-2) physical downlink control channel (PDCCH) or physical downlink shared channel (PDSCH) repetition, message 3 (MSG-3) physical uplink shared channel (PUSCH) repetition, or message 4 (MSG-4) PDCCH, PDSCH, or PUSCH repetition.

Clause 19. The method of any one of clauses 10-18, wherein the first set of resources or the second set of resources includes at least one random access occasion (RO) to be used for transmitting the RACH message, or a preamble to be used for transmitting the RACH message.

Clause 20. A method for wireless communication by a base station (BS), comprising: transmitting, to a user equipment (UE), a message comprising random access channel (RACH) configurations including a first RACH configuration indicating a first set of resources for reduced capability UEs supporting at least one first capability, a second RACH configuration indicating a second set of resources for coverage enhanced UEs supporting at least one second capability, and a third RACH configuration indicating a third set of resources for UEs supporting the at least one first capability and the at least one second capability; and receiving a RACH message based on at least one of the RACH configurations.

Clause 21. The method of clause 20, wherein the first set of resources and the second set of resources comprise overlapping resources, and wherein the third set of resources comprises the overlapping resources.

Clause 22. The method of clause 21, wherein the first set of resources and the second set of resources comprise overlapping resources in time and frequency.

Clause 23. The method of any one of clauses 20-22, wherein receiving the RACH message comprises receiving an indication that the UE is a reduced capability UE.

Clause 24. The method of any one of clauses 20-23, wherein receiving the RACH message comprises receiving an indication associated with repetition of a RACH procedure message.

Clause 25. The method of clause 24, wherein the indication associated with the repetition includes a coverage enhanced repetition capability or preference.

Clause 26. The method of any one of clauses 20-25, wherein the reduced capability UEs supporting the at least one first capability include UEs supporting at least one of a reduced bandwidth configuration, reduced receiver configuration, or half duplex (HD) frequency division duplexing (FDD).

Clause 27. The method of any one of clauses 20-26, wherein the coverage enhanced UEs supporting the at least one second capability comprise UEs supporting at least one of message 2 (MSG-2) physical downlink control channel (PDCCH) or physical downlink shared channel (PDSCH) repetition, message 3 (MSG-3) physical uplink shared channel (PUSCH) repetition, or message 4 (MSG-4) PDCCH, PDSCH, or PUSCH repetition.

Clause 28. The method of any one of clauses 20-27, wherein the first set of resources, the second set of resources, or the third set of resources includes at least one random access occasion (RO) to be used for transmitting the RACH message, or a preamble to be used for transmitting the RACH message.

Clause 29. A method for wireless communication by a base station (BS), comprising: transmitting, to a user equipment (UE), a message comprising random access channel (RACH) configurations including a first RACH configuration indicating a first set of resources for reduced capability UEs supporting at least one first capability, a second configuration indicating a second set of resources for coverage enhanced UEs supporting at least one second capability, wherein the first set of resources and the second set of resources comprise overlapping resources; and receiving a RACH message based on the RACH configurations.

Clause 30. The method of clause 29, wherein the first set of resources and the second set of resources comprise overlapping resources in time and frequency.

Clause 31. The method of any one of clauses 29-30, wherein the at least one first capability is associated with reduced capability UEs, and wherein the at least one second capability is associated with coverage enhanced UEs.

Clause 32. The method of any one of clauses 29-31, wherein receiving the RACH message comprises receiving an indication that the UE is a reduced capability UE.

Clause 33. The method of any one of clauses 29-32, wherein receiving the RACH message comprises receiving an indication associated with repetition of a RACH procedure message.

Clause 34. The method of clause 33, wherein the indication associated with the repetition includes a coverage enhanced repetition capability or preference.

Clause 35. The method of any one of clauses 29-34, wherein the reduced capability UEs supporting the at least one first capability comprise UEs supporting at least one of a reduced bandwidth configuration, reduced receiver configuration, or half duplex (HD) frequency division duplexing (FDD).

Clause 36. The method of any one of clauses 29-35, wherein the coverage enhanced UEs supporting the at least one second capability includes UEs supporting at least one of message 2 (MSG-2) physical downlink control channel (PDCCH) or physical downlink shared channel (PDSCH) repetition, message 3 (MSG-3) physical uplink shared channel (PUSCH) repetition, or message 4 (MSG-4) PDCCH, PDSCH, or PUSCH repetition.

Clause 37. The method of any one of clauses 29-36, wherein the first set of resources or the second set of resources includes at least one random access occasion (RO) to be used for transmitting the RACH message, or a preamble to be used for transmitting the RACH message.

Clause 38: An apparatus, comprising: a memory comprising executable instructions; one or more processors configured to execute the executable instructions and cause the apparatus to perform a method in accordance with any one of Clauses 1-37.

Clause 39: An apparatus, comprising means for performing a method in accordance with any one of Clauses 1-37.

Clause 40: A non-transitory computer-readable medium comprising executable instructions that, when executed by one or more processors of an apparatus, cause the apparatus to perform a method in accordance with any one of Clauses 1-37.

Clause 41: A computer program product embodied on a computer-readable storage medium comprising code for performing a method in accordance with any one of Clauses 1-37.

### Additional Wireless Communication Network Considerations

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmWave), machine type communications (MTC), and/or mission critical targeting ultra-reliable, low-latency communications (URLLC). These services, and others, may include latency and reliability requirements.

Returning to FIG. 1, various aspects of the present disclosure may be performed within the example wireless communication network 100.

In 3GPP, the term “cell” can refer to a coverage area of a NodeB and/or a narrowband subsystem serving this coverage area, depending on the context in which the term is used. In NR systems, the term “cell” and BS, next generation NodeB (gNB or gNodeB), access point (AP), distributed unit (DU), carrier, or transmission reception point may be used interchangeably. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area (e.g., a sports stadium) and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG) and UEs for users in the home). A BS for a macro cell may be referred to as a macro BS. A BS for a pico cell may be referred to as a pico BS. A BS for a femto cell may be referred to as a femto BS, home BS, or a home NodeB.

Base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). Base stations 102 configured for 5G (e.g., 5G NR or Next Generation RAN (NG-RAN)) may interface with 5GC 190 through second backhaul links 184. Base stations 102 may communicate directly or indirectly (e.g., through the EPC 160 or 5GC 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as gNB 180 may operate in a traditional sub-6 GHz spectrum, in millimeter wave (mmWave) frequencies, and/or near mmWave frequencies in communication with the UE 104. When the gNB 180 operates in mmWave or near mmWave frequencies, the gNB 180 may be referred to as an mmWave base station.

The communication links 120 between base stations 102 and, for example, UEs 104, may be through one or more carriers. For example, base stations 102 and UEs 104 may use spectrum up to Y MHz (e.g., 5, 10, 15, 20, 100, 400, and other MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Wireless communications system 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152/AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

5GC 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and 5GC 190. Generally, AMF 192 provides QoS flow and session management.

All user Internet protocol (IP) packets are transferred through UPF 195, which is connected to the IP Services 197, and which provides UE IP address allocation as well as other functions for 5GC 190. IP Services 197 may include, for example, the Internet, an intranet, an IP Multimedia Subsystem (IMS), a PS Streaming Service, and/or other IP services.

Returning to FIG. 2, various example components of BS 102 and UE 104 (e.g., the wireless communication network 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), and others. The data may be for the physical downlink shared channel (PDSCH), in some examples.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

Processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the physical uplink shared channel (PUSCH)) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 102.

At BS 102, the uplink signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones and bins. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, and others).

As above, FIGS. 3A-3D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A-3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Additional Considerations

The preceding description provides examples of random access channel communication in communication systems. The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, and others. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, and others. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (see FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for wireless communication by a user equipment (UE), comprising:
receiving, from a base station, a message comprising random access channel (RACH) configurations including a first RACH configuration indicating a first set of resources for reduced capability UEs supporting at least one first capability, a second RACH configuration indicating a second set of resources for coverage enhanced UEs supporting at least one second capability, and a third RACH configuration indicating a third set of resources for UEs supporting the at least one first capability and the at least one second capability; and
transmitting a RACH message based on at least one of the RACH configurations.

2. The method of claim 1, wherein the first set of resources and the second set of resources comprise overlapping resources, and wherein the third set of resources comprises the overlapping resources.

3. The method of claim 2, wherein the first set of resources and the second set of resources comprise overlapping resources in time and frequency.

4. The method of claim 1, wherein transmitting the RACH message comprises transmitting an indication that the UE is a reduced capability UE.

5. The method of claim 1, wherein transmitting the RACH message comprises transmitting an indication associated with repetition of a RACH procedure message.

6. The method of claim 5, wherein the indication associated with the repetition includes a coverage enhanced repetition capability or preference.

7. The method of claim 1, wherein the reduced capability UEs supporting the at least one first capability include UEs supporting at least one of a reduced bandwidth configuration, reduced receiver configuration, or half duplex (HD) frequency division duplexing (FDD).

8. The method of claim 1, wherein the coverage enhanced UEs supporting the at least one second capability comprise UEs supporting at least one of message 2 (MSG-2) physical downlink control channel (PDCCH) or physical downlink shared channel (PDSCH) repetition, message 3 (MSG-3) physical uplink shared channel (PUSCH) repetition, or message 4 (MSG-4) PDCCH, PDSCH, or PUSCH repetition.

9. The method of claim 1, wherein the first set of resources, the second set of resources, or the third set of resources includes at least one random access occasion (RO) to be used for transmitting the RACH message, or a preamble to be used for transmitting the RACH message.

10. A method for wireless communication by a user equipment (UE), comprising:
receiving, from a base station, a message comprising random access channel (RACH) configurations including a first RACH configuration indicating a first set of resources for reduced capability UEs supporting at least one first capability, a second configuration indicating a second set of resources for coverage enhanced UEs supporting at least one second capability, wherein the first set of resources and the second set of resources comprise overlapping resources; and
transmitting a RACH message based on the RACH configurations.

11. The method of claim 10, wherein the first set of resources and the second set of resources comprise overlapping resources in time and frequency.

12. The method of claim 10, wherein transmitting the RACH message based on the RACH configurations includes avoiding transmission of the RACH message using the overlapping resources.

13. The method of claim 10, wherein the at least one first capability is associated with reduced capability UEs, and wherein the at least one second capability is associated with coverage enhanced UEs.

14. The method of claim 10, wherein transmitting the RACH message comprises transmitting an indication that the UE is a reduced capability UE.

15. The method of claim 10, wherein transmitting the RACH message comprises transmitting an indication associated with repetition of a RACH procedure message.

16. The method of claim 15, wherein the indication associated with the repetition includes a coverage enhanced repetition capability or preference.

17. The method of claim 10, wherein the reduced capability UEs supporting the at least one first capability comprise UEs supporting at least one of a reduced bandwidth configuration, reduced receiver configuration, or half duplex (HD) frequency division duplexing (FDD).

18. The method of claim 10, wherein the coverage enhanced UEs supporting the at least one second capability includes UEs supporting at least one of message 2 (MSG-2) physical downlink control channel (PDCCH) or physical downlink shared channel (PDSCH) repetition, message 3 (MSG-3) physical uplink shared channel (PUSCH) repetition, or message 4 (MSG-4) PDCCH, PDSCH, or PUSCH repetition.

19. The method of claim 10, wherein the first set of resources or the second set of resources includes at least one random access occasion (RO) to be used for transmitting the RACH message, or a preamble to be used for transmitting the RACH message.

20. A method for wireless communication by a base station (BS), comprising:
transmitting, to a user equipment (UE), a message comprising random access channel (RACH) configurations including a first RACH configuration indicating a first set of resources for reduced capability UEs supporting at least one first capability, a second RACH configuration indicating a second set of resources for coverage enhanced UEs supporting at least one second capability, and a third RACH configuration indicating a third set of resources for UEs supporting the at least one first capability and the at least one second capability; and
receiving a RACH message based on at least one of the RACH configurations.

21. The method of claim 20, wherein the first set of resources and the second set of resources comprise overlapping resources, and wherein the third set of resources comprises the overlapping resources.

22. The method of claim 21, wherein the first set of resources and the second set of resources comprise overlapping resources in time and frequency.

23. The method of claim 20, wherein receiving the RACH message comprises receiving an indication that the UE is a reduced capability UE.

24. The method of claim 20, wherein receiving the RACH message comprises receiving an indication associated with repetition of a RACH procedure message.

25. The method of claim 24, wherein the indication associated with the repetition includes a coverage enhanced repetition capability or preference.

26. The method of claim 20, wherein the reduced capability UEs supporting the at least one first capability include UEs supporting at least one of a reduced bandwidth configuration, reduced receiver configuration, or half duplex (HD) frequency division duplexing (FDD).

27. The method of claim 20, wherein the coverage enhanced UEs supporting the at least one second capability comprise UEs supporting at least one of message 2 (MSG-2) physical downlink control channel (PDCCH) or physical downlink shared channel (PDSCH) repetition, message 3 (MSG-3) physical uplink shared channel (PUSCH) repetition, or message 4 (MSG-4) PDCCH, PDSCH, or PUSCH repetition.

28. The method of claim 20, wherein the first set of resources, the second set of resources, or the third set of resources includes at least one random access occasion (RO) to be used for transmitting the RACH message, or a preamble to be used for transmitting the RACH message.

29. A method for wireless communication by a base station (BS), comprising:
transmitting, to a user equipment (UE), a message comprising random access channel (RACH) configurations including a first RACH configuration indicating a first set of resources for reduced capability UEs supporting at least one first capability, a second configuration indicating a second set of resources for coverage enhanced UEs supporting at least one second capability, wherein the first set of resources and the second set of resources comprise overlapping resources; and
receiving a RACH message based on the RACH configurations.

30. The method of claim 29, wherein the first set of resources and the second set of resources comprise overlapping resources in time and frequency.

31. The method of claim 29, wherein the at least one first capability is associated with reduced capability UEs, and wherein the at least one second capability is associated with coverage enhanced UEs.

32. The method of claim 29, wherein receiving the RACH message comprises receiving an indication that the UE is a reduced capability UE.

33. The method of claim 29, wherein receiving the RACH message comprises receiving an indication associated with repetition of a RACH procedure message.

34. The method of claim 33, wherein the indication associated with the repetition includes a coverage enhanced repetition capability or preference.

35. The method of claim 29, wherein the reduced capability UEs supporting the at least one first capability comprise UEs supporting at least one of a reduced bandwidth configuration, reduced receiver configuration, or half duplex (HD) frequency division duplexing (FDD).

36. The method of claim 29, wherein the coverage enhanced UEs supporting the at least one second capability includes UEs supporting at least one of message 2 (MSG-2) physical downlink control channel (PDCCH) or physical downlink shared channel (PDSCH) repetition, message 3 (MSG-3) physical uplink shared channel (PUSCH) repetition, or message 4 (MSG-4) PDCCH, PDSCH, or PUSCH repetition.

37. The method of claim 29, wherein the first set of resources or the second set of resources includes at least one random access occasion (RO) to be used for transmitting the RACH message, or a preamble to be used for transmitting the RACH message.
